(19) United States
(12) Patent Application Publication
(10) Pub. No.: US 2025/0148715 A1
(43) Pub. Date: May 8, 2025

(54) EFFICIENT GEOMETRY COMPONENT CODING FOR DYNAMIC MESH CODING

(71) Applicant: GUANGDONG OPPO MOBILE TELECOMMUNICATIONS CORP., LTD., Dongguan, Guangdong (CN)

(72) Inventors: Vladyslav ZAKHARCHENKO, Palo Alto, CA (US); Haoping YU, Palo Alto, CA (US); Yue YU, Palo Alto, CA (US)

(21) Appl. No.: 18/840,747

(22) PCT Filed: Feb. 24, 2023
(86) PCT No.: PCT/US2023/063201

§ 371 Date: Aug. 22, 2024

Related U.S. Application Data
(60) Provisional application No. 63/268,486, filed on Feb. 24, 2022.

(51) Int. Cl. G06T 17/20; G06T 9/00

(52) U.S. Cl. CPC G06T 17/20; G06T 9/001

(57) ABSTRACT

In some embodiments, a mesh encoder encodes a dynamic mesh with efficient geometry coding. The encoder normalizes and integerizes the coordinates of vertices of a mesh frame. The encoder segments the integerized coordinates for the vertices into 3D sub-blocks, each 3D sub-block containing at least one vertex and local coordinates of vertices in each 3D sub-block having a value range fitting into a video bit depth. For each 3D sub-block, the encoder converts coordinates of a vertex inside the 3D sub-block to a local coordinate system of the 3D sub-block and maps each vertex inside the 3D sub-block to a corresponding 2D patch in a geometry component image that represents the mesh frame. The encoder compresses the geometry component image to generate a geometry component bitstream and further generates the coded mesh bitstream for the dynamic mesh by including the geometry component bitstream.

### CROSS-REFERENCE TO RELATED APPLICATIONS

This application is a U.S. National Stage entry under 35 U.S.C. § 371 of International Application No. PCT/US2023/063201, filed on Feb. 24, 2023, which claims priority to U.S. Provisional Application No. 63/268,486, filed on Feb. 24, 2022, the entire disclosures of which are hereby incorporated by reference.

### TECHNICAL FIELD

This disclosure relates generally to computer-implemented methods and systems for dynamic mesh coding. Specifically, the present disclosure involves geometry component coding for dynamic mesh coding.

### BACKGROUND

3D graphics technologies are integrated in various applications, such as entertainment applications, engineering applications, manufacturing applications, and architecture applications. In these various applications, 3D graphics may be used to generate 3D models of incredible detail and complexity. Given the detail and complexity of the 3D models, the data sets associated with the 3D models can be extremely large. Furthermore, these extremely large data sets may be transferred, for example, through the Internet. Transfer of large data sets, such as those associated with detailed and complex 3D models, can therefore become a bottleneck in various applications. As illustrated by this example, developments in 3D graphics technologies provide improved utility to various applications but also present technological challenges. Improvements to 3D graphics technologies, therefore, represent improvements to the various technological applications to which 3D graphics technologies are applied. Thus, there is a need for technological improvements to address these and other technological problems related to 3D graphics technologies.

### SUMMARY

Some embodiments involve efficient geometry component coding for dynamic mesh coding. In one example, a computer-implemented method for encoding three-dimensional (3D) content represented by a dynamic mesh includes normalizing coordinates of each vertex of a plurality of vertices in a mesh frame of the dynamic mesh; integerizing the coordinates of each vertex of the plurality of vertices; and segmenting the integerized coordinates for the plurality of vertices into one or more 3D sub-blocks. Each 3D sub-block contains at least one vertex of the plurality of vertices, and local coordinates of vertices in each 3D sub-block have a value range fitting into a video bit depth. The method further includes, for each 3D sub-block, converting coordinates of a vertex inside the 3D sub-block to a local coordinate system of the 3D sub-block, and mapping each vertex inside the 3D sub-block to a corresponding 2D patch in a geometry component image of the dynamic mesh that represents the mesh frame. The method further includes compressing the geometry component image and other geometry component images of the dynamic mesh using a video encoder to generate a geometry component bitstream; and generating a coded mesh bitstream for the dynamic mesh by including at least the geometry component bitstream.

In another example, a non-transitory computer-readable medium stores a coded mesh bitstream generated according to the following operations. The operations include normalizing coordinates of each vertex of a plurality of vertices in a mesh frame of a dynamic mesh; integerizing the coordinates of each vertex of the plurality of vertices; and segmenting the integerized coordinates for the plurality of vertices into one or more 3D sub-blocks. Each 3D sub-block contains at least one vertex of the plurality of vertices, and local coordinates of vertices in each 3D sub-block have a value range fitting into a video bit depth. The operations include, for each 3D sub-block, converting coordinates of a vertex inside the 3D sub-block to a local coordinate system of the 3D sub-block and mapping each vertex inside the 3D sub-block to a corresponding 2D patch in a geometry component image of the dynamic mesh that represents the mesh frame. The operations further include compressing the geometry component image and other geometry component images of the dynamic mesh using a video encoder to generate a geometry component bitstream; and generating the coded mesh bitstream for the dynamic mesh by including at least the geometry component bitstream.

In another example, a computer-implemented method for decoding a coded mesh bitstream of a dynamic mesh representing three-dimensional (3D) content includes generating a geometry component image for a mesh frame of the dynamic mesh by decoding a geometry component bitstream in the coded mesh bitstream; reconstructing coordinates of vertices in a local coordinate system of a 3D sub-block of the mesh frame from a corresponding 2D patch in the geometry component image by converting color information from color planes of the corresponding 2D patch to the coordinates of vertices in the local coordinate system of the 3D sub-block; reconstructing global coordinates of the vertices in the mesh frame from the coordinates of vertices in the local coordinate system of the 3D sub-block; reconstructing geometry coordinates of the vertices by applying inverse integerization based on integerization parameter for geometry information of the dynamic mesh; reconstructing the dynamic mesh based, at least in part, on the reconstructed geometry coordinates; and causing the reconstructed dynamic mesh to be rendered for display.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates an example encoder system for mesh coding, according to various embodiments of the present disclosure.

FIG. 2 illustrates an example decoder system for mesh decoding, according to various embodiments of the present disclosure.

FIG. 3 illustrates example mesh frames associated with color-per-vertex approaches, according to various embodiments of the present disclosure.

FIG. 4 illustrates an example of a mesh frame and its underlying defining data associated with color-per-vertex approaches and a corresponding 3D content, according to various embodiments of the present disclosure.

FIG. 5 illustrates example mesh frames associated with 3D coding approaches using vertex maps, according to various embodiments of the present disclosure.

FIG. 6 illustrates an example of data defining a mesh frame, a corresponding 3D content, and a corresponding attribute map associated with 3D coding approaches using attribute mapping, according to various embodiments of the present disclosure.

FIG. 7 illustrates an example associated with determining face orientation in various 3D coding approaches, according to various embodiments of the present disclosure.

FIG. 8 illustrates an example of a 3D sub-block segmentation process for a mesh frame, according to various embodiments of the present disclosure.

FIG. 9 shows an example of a picture composition for a geometry patch, according to various embodiments of the present disclosure.

FIG. 10 provides an example of a 2D patch composition image, according to some embodiments of the present disclosure.

FIG. 11 illustrates examples of color space subsampling for geometry coding, according to various embodiments of the present disclosure.

FIG. 12 depicts an example of a process for mesh coding with connectivity simplification, according to some embodiments of the present disclosure.

FIG. 13 depicts an example of a process for decoding a coded mesh bitstream with efficient geometry component coding, according to some embodiments of the present disclosure.

FIG. 14 depicts an example of a computing system that can be used to implement some embodiments of the present disclosure.

### DETAILED DESCRIPTION

Various embodiments provide geometry component coding for dynamic mesh coding to improve coding efficiency. Dynamic mesh coding involves encoding images generated from various information of the mesh, such as the geometry information, using video encoders. However, video coding typically has a smaller bit depth than that of the geometry information. As a result, when mapping the geometry information to the image samples, large errors are introduced into the coding process due to the reduction of the number of bits used to represent the geometry data. Various embodiments described herein involve the encoding and decoding of geometry information of the dynamic mesh with improved precision and efficiency.

The following non-limiting examples are provided to introduce some embodiments. In one embodiment, a mesh encoder accesses a dynamic mesh to be encoded. The dynamic mesh may be represented as uncompressed mesh frame sequence that include mesh frames. Each mesh frame includes at least one mesh tile or mesh slice which includes data that describes three-dimensional (3D) content (e.g., 3D objects) in a digital representation as a collection of geometry, connectivity, attribute, and attribute mapping information. The encoder can extract an attribute component (containing color information), a geometry component (containing a list of vertex coordinates), a connectivity component (containing a list of faces with corresponding vertex index and texture index), and a mapping component (containing a list of projected vertex attribute coordinate information) from the uncompressed mesh frame sequence.

The encoder encodes the geometry component by segmenting normalized and integerized coordinates of the vertices in a mesh frame into one or more 3D sub-blocks. The encoder further converts the coordinates of the vertices inside the 3D sub-block to a local coordinate system of the 3D sub-block. The segmentation is performed in a way that each 3D sub-block contains at least one vertex of the plurality of vertices, and local coordinates of vertices in each 3D sub-block have a value range fitting into the video bit depth. The local coordinates of vertices in each 3D sub-block can be determined based on the global coordinates of the vertices in the coordinate system of the mesh frame and the coordinates of the origin of the 3D sub-block. Each vertex inside a 3D sub-block can be mapped to a corresponding two-dimensional (2D) patch in the geometry component image of the mesh frame. The encoder compresses the geometry component image and other geometry component images of the dynamic mesh using a video encoder to generate a geometry component bitstream. The encoder further encodes the geometry component bitstream and other components to generates a coded mesh bitstream for the dynamic mesh.

By segmenting the vertices in a mesh frame into one or more 3D sub-blocks and converts the coordinates of the vertices inside the 3D sub-block to a local coordinate system of the 3D sub-block, the encoder is able to reduce the value range of the vertex coordinates and to provide spatial partial decoding capabilities. The reduced range can thus fit into the lower bit depth of the video encoding. As a result, the mapping or projection of the vertices in the 3D sub-blocks into 2D image patches does not incur precision reduction, and the precision can in fact be increased by subdividing the mesh frame into sub-blocks with a local coordinate system. Consequently, the overall precision of the encoding process is increased.

In addition, by segmenting vertices into 3D sub-blocks and projecting each sub-block into one 2D patch as disclosed herein, the encoding of the atlas information of the dynamic mesh can be simplified. For example, the proposed geometry encoding eliminates the need to encode the occupancy map, thereby reducing the size of the encoded geometry bitstream and increasing the coding efficiency. Furthermore, the integerization of the geometry coordinates from floating values to integer values simplifies the implementation of the geometry information encoding and decoding by allowing fewer bits to represent a coordinate value. Integrated circuits operate more efficiently with integer (fixed point) values than floating point values. Consequently, the mesh encoding and decoding can be performed faster using less memory.

Descriptions of the various embodiments provided herein may include one or more of the terms listed below. For illustrative purposes and not to limit the disclosure, exemplary descriptions of the terms are provided herein.
Mesh: a collection of vertices, edges, and faces that may define the shape/topology of a polyhedral object. The faces may include triangles (e.g., triangle mesh).
Mesh slice: a collection of vertices, edges, and faces that may define the shape/topology of a polyhe. A mesh frame consists of several mesh slices.
Dynamic mesh: a mesh with at least one of various possible components (e.g., connectivity, geometry, mapping, vertex attribute, and attribute map) varying in time.
Animated Mesh: a dynamic mesh with constant connectivity.
Connectivity: a set of vertex indices describing how to connect the mesh vertices to create a 3D surface (e.g., geometry and all the attributes may share the same unique connectivity information).
Geometry: a set of vertex 3D (e.g., x, y, z) coordinates describing positions associated with the mesh vertices. The coordinates (e.g., x, y, z) representing the positions may have finite precision and dynamic range.
Mapping: a description of how to map the mesh surface to 2D regions of the plane. Such mapping may be described by a set of UV parametric/texture (e.g., mapping) coordinates associated with the mesh vertices together with the connectivity information.
Vertex attribute: a scalar of vector attribute values associated with the mesh vertices.
Attribute Map: attributes associated with the mesh surface and stored as 2D images/videos. The mapping between the videos (e.g., parametric space) and the surface may be defined by the mapping information.
Vertex: a position (e.g., in 3D space) along with other information such as color, normal vector, and texture coordinates.
Edge: a connection between two vertices.
Face: a closed set of edges in which a triangle face has three edges defined by three vertices. Orientation of the face may be determined using a “right-hand” coordinate system.
Orientation of a face: defined by vertex order in the face. Some transpositions are allowed, while other transpositions of the vertexes in the face lead to a different orientation.
Surface: a collection of faces that separates the three-dimensional object from the environment.
Connectivity Coding Unit (CCU): a square unit of size N×N connectivity coding samples that carry connectivity information.
Connectivity Coding Sample: a coding element of the connectivity information calculated as a difference of elements between a current face and a predictor face.
Block: a representation of the mesh segment as a collection of connectivity coding samples represented as three attribute channels. A block may consist of CCUs.
bits per point (bpp): an amount of information in terms of bits, which may be required to describe one point in the mesh.

3D content, such as 3D graphics, can be represented as a mesh (e.g., 3D mesh content). The mesh can include vertices, edges, and faces that describe the shape or topology of the 3D content. The mesh can be segmented into blocks (e.g., segments, tiles). For each block, the vertex information associated with each face can be arranged in order (e.g., descending order). With the vertex information associated with each face arranged in order, the faces are arranged in order (e.g., ascending order). The sorted faces in each block can be packed into two-dimensional (2D) frames. Sorting the vertex information can guarantee an increasing order of vertex indices, facilitating improved processing of the mesh. Components of the connectivity information in the 3D mesh content can be transformed from one-dimensional (1D) connectivity components (e.g., list, face list) to 2D connectivity images (e.g., connectivity coding sample array). With the connectivity information in the 3D mesh content transformed to 2D connectivity images, video encoding processes can be applied to the 2D connectivity images (e.g., as video connectivity frames). In this way, 3D mesh content can be efficiently compressed and decompressed by leveraging video encoding solutions. 3D mesh content encoded in accordance with these approaches can be efficiently decoded. Connectivity components can be extracted from a coded dynamic mesh bitstream and decoded as a frame (e.g., image). Connectivity coding samples, which correspond with pixels in the frame, are extracted. The 3D mesh content can be reconstructed from the connectivity information extracted.

A coded bitstream for dynamic mesh is represented as a collection of components, which is composed of mesh bitstream header and data payload. The mesh bitstream header can include the sequence parameter set, picture parameter set, adaptation parameters, tile information parameters, and supplemental enhancement information, etc. The mesh bitstream payload can include the coded atlas information component (auxiliary information required to convert the local coordinate system of the block to the global coordinate system of the mesh frame), coded attribute information component, coded geometry (position) information component, coded mapping information component, and coded connectivity information component.

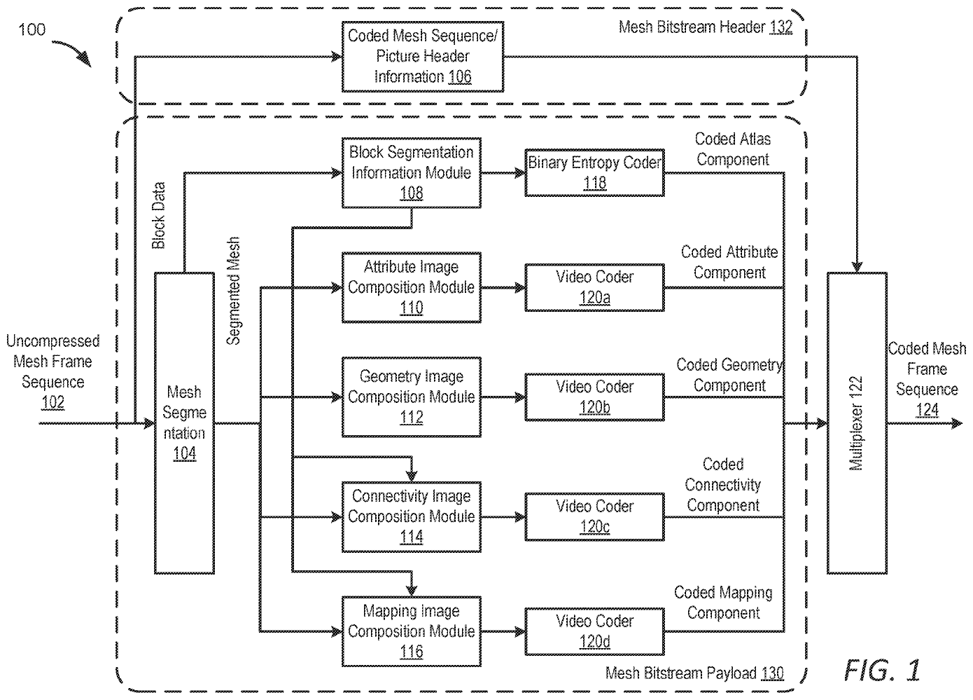

FIG. 1 illustrates an example encoder system 100 for mesh coding, according to various embodiments of the present disclosure. As illustrated in FIG. 1, an uncompressed mesh frame sequence 102 can be input to the encoder system 100, and the example encoder system 100 can generate a coded mesh frame sequence 124 based on the uncompressed mesh frame sequence 102. In general, a mesh frame sequence includes mesh frames. A mesh frame is a data format that describes 3D content (e.g., 3D objects) in a digital representation as a collection of geometry, connectivity, attribute, and attribute mapping information. Each mesh frame is characterized by a presentation time and duration. A mesh frame sequence (e.g., sequence of mesh frames) forms a dynamic mesh video.

As illustrated in FIG. 1, the encoder system 100 can generate coded mesh sequence/picture header information 106 based on the uncompressed mesh frame sequence 102. The coded mesh sequence/picture header information 106 can include picture header information such as sequence parameter set (SPS), picture parameter set (PPS), slice header (SH) and supplemental enhancement information (SEI). A mesh bitstream header 132 can include the coded mesh sequence/picture header information 106. The uncompressed mesh frame sequence 102 can be input to the mesh segmentation module 104. The mesh segmentation module 104 segments the uncompressed mesh frame sequence 102 into block data and segmented mesh data. A mesh bitstream payload 130 can include the block data and the segmented mesh data. The mesh bitstream header 132 and the mesh bitstream payload 130 can be multiplexed together by the multiplexer 122 to generate the coded mesh frame sequence 124.

The encoder system 100 can include a block segmentation information module 108 to generate block segmentation information (e.g., atlas information) based on the block data. Based on the segmented mesh data, the encoder system 100 can generate uncompressed attribute component using an attribute image composition module 110, uncompressed geometry component using a geometry image composition module 112, uncompressed connectivity component using a connectivity image composition module 114, and uncompressed mapping component using a mapping image composition module 116. As illustrated in FIG. 1, the connectivity image composition module 114 and the mapping image composition module 116 can also use the block segmentation information generated by the block segmentation information module 108 when generating the respective components. As an example of the information generated, the block segmentation information can include binary atlas information. The attribute image component can include RGB and YUV component information (e.g., RGB 4:4:4, YUV 4:2:0). The geometry component can include the 3D coordinates of the vertex information in canonical or local coordinate system (e.g., XYZ 4:4:4, XYZ 4:2:0). The connectivity component can include vertex indices and texture vertex information (e.g., dv0, dv1, dv2 4:4:4). The mapping component can include texture vertex information (e.g., UV 4:4:X). These generated components may be represented as images.

The block segmentation information can be provided to a binary entropy coder 118 to generate atlas component. The binary entropy coder 118 may be a lossless coder which allows the encoded information to be recovered without any distortion. The uncompressed attribute component generated by the attribute image composition module 110 and represented as images can be provided to a video coder 120a to generate the coded attribute component. The video coder 120a may be a lossy coder where the encoded information may not be fully recovered at the decoder side. Similarly, the geometry component represented as images can be provided to a video coder 120b to generate coded geometry component. The video coder 120b may also be a lossy encoder. The connectivity image component represented as images can be provided to video coder 120c to generate coded connectivity component. The video coder 120c may be a lossless encoder. The mapping component represented as images can be provided to video coder 120d to generate coded mapping component. The video coder 120d may be a lossless encoder. The video coders 120a-120d may be any video or image encoder that can compress the information in a video sequence or images to reduce the size of the video, such as the H.264 video encoder, H. 265 video encoder, H.266 video encoder, JPEG image encoder, and so on. The video coders 120a-120d may use the same type or different types of video encoders. A mesh bitstream payload 130 can include the atlas component, the attribute component, the geometry component, the connectivity component, and the mapping component. The mesh bitstream payload and the mesh bitstream header are multiplexed together by the multiplexer 122 to generate the coded mesh frame sequence 124.

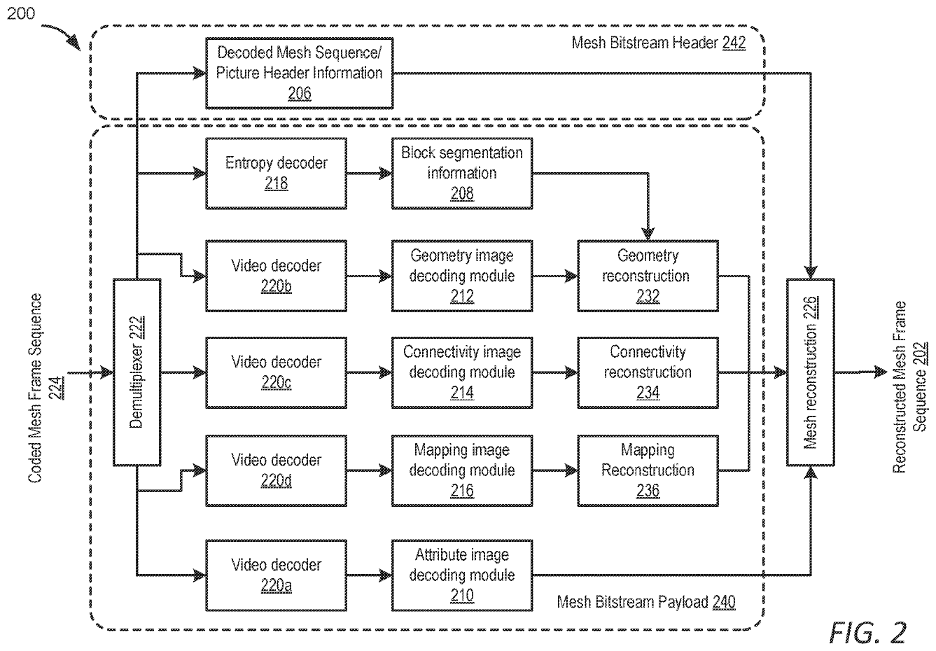

FIG. 2 illustrates an example decoder system 200 for mesh decoding, according to various embodiments of the present disclosure. As illustrated in FIG. 2, a coded mesh frame sequence 224, such as the coded mesh frame sequence 124 generated by the encoder system 100 in FIG. 1 can be input to the decoder system 200. The coded mesh frame sequence 224 may be a bitstream. The example decoder system 200 can generate a reconstructed mesh frame sequence 202 based on the coded mesh frame sequence 224.

As illustrated in FIG. 2, the decoder system 200 de-multiplexes the coded mesh frame sequence 224 using a de-multiplexer 222 to identify various components of the coded information, including the coded mesh sequence/picture/slice header information 206 and the coded block segmentation information, which can be decoded using an entropy decoder 218. The de-multiplexed information further includes the coded geometry component, the coded connectivity image component, the coded mapping component, and the coded attribute component. The identified various coded component can be decoded using video decoders 220a-220d corresponding to the respective video encoders used to encode the information as indicated in coded mesh sequence header 106, such as video coders 120a-120d. Similar to the video coders 120a-120d, the video decoders 220a-220d can be any video decoder or image decoder.

The video decoded data can further be processed using the respective processing modules, such as the attribute image decoding module 210, the geometry image decoding module 212, the connectivity image decoding module 214, and the mapping image decoding module 216. These decoding modules convert the decoded video data into the respective formats of the data. For example, for geometry data, the decoded images in the video can be reformatted back into canonical XYZ 3D coordinates to generate the geometry data. Likewise, the decoded connectivity video/images can be reformatted into connectivity coded samples dv0, dv1, dv2 to generate the decoded connectivity data; the decoded mapping video/images can be reformatted into uv coordinates to generate the decoded mapping data; and the decoded attribute video/images can be used to generate the RGB or YUV attribute data of the mesh.

The geometry reconstruction module 232 reconstructs the geometry information from the decoded 3D coordinates; the connectivity reconstruction module 234 reconstructs the topology (e.g., faces) from the decoded connectivity data; and the mapping reconstruction module 236 reconstructs the attribute mapping from the decoded mapping data. With the reconstructed geometry information, faces, mapping data, attribute data, and the decoded mesh sequence/picture header information 206, a mesh reconstruction module 226 reconstructs the mesh to generate the reconstructed mesh frame sequence 202.

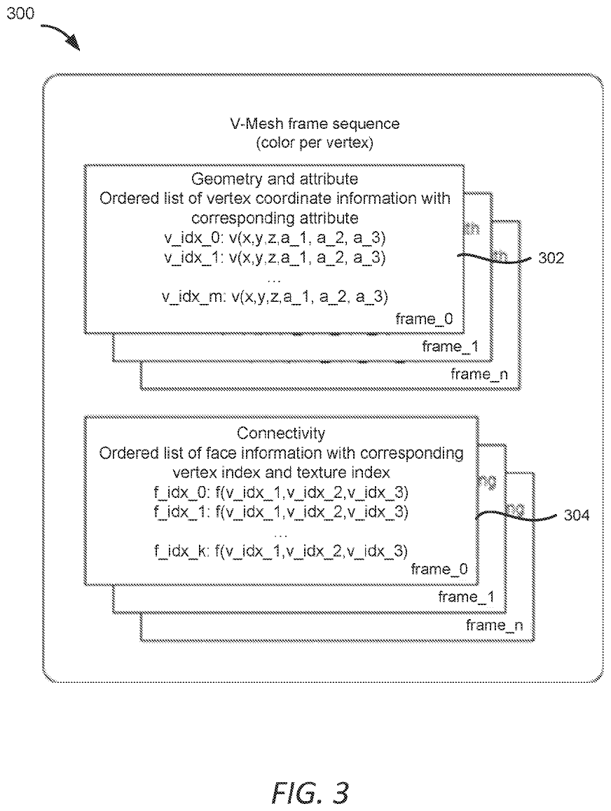

FIGS. 3-7 illustrate examples associated with coding and decoding information for a mesh, according to various embodiments of the present disclosure. In various approaches to coding 3D content, geometry, attribute, and connectivity information are encoded in mesh frames. For example, in color-per-vertex approaches, attribute information is stored with the geometry information and connectivity information are stored in mesh frames with associated vertex indices. FIG. 3 illustrates example mesh frames 300 associated with color-per-vertex approaches, according to various embodiments of the present disclosure. As illustrated in FIG. 3, geometry and attribute information 302 can be stored in mesh frames as an ordered list of vertex coordinate information. Each vertex coordinate is stored with corresponding geometry and attribute information. Connectivity information 304 can be stored in mesh frames as an ordered list of face information, with each face including corresponding vertex indices and texture indices.

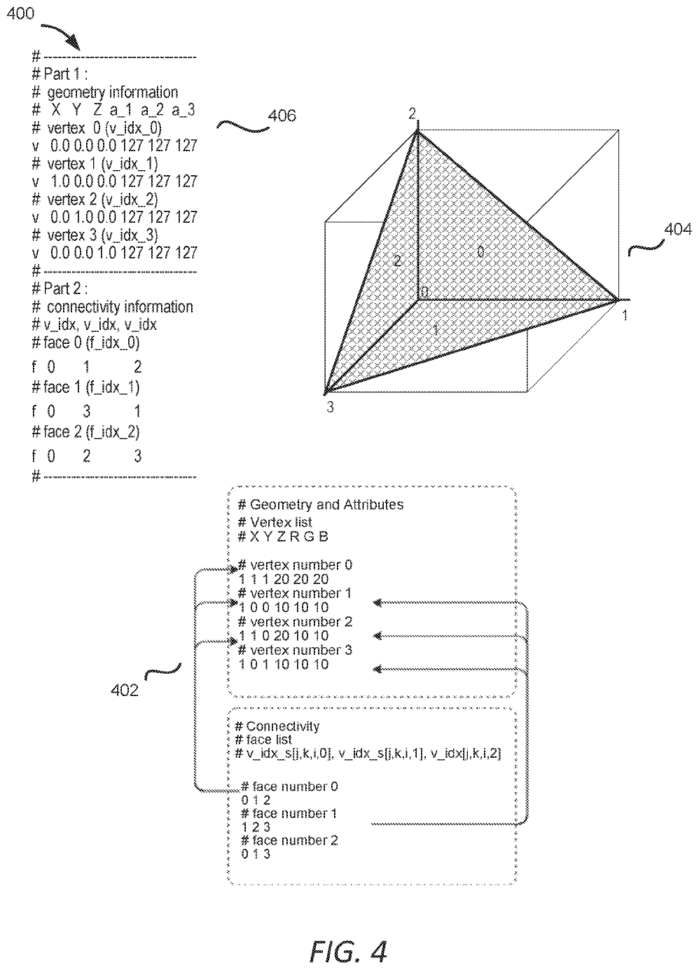

FIG. 4 illustrates an example 400 of a mesh frame 402 and its underlying defining data 406 associated with color-per-vertex approaches and a corresponding 3D content 404, according to various embodiments of the present disclosure. As illustrated in mesh frame 402 and defined in the corresponding data 406, geometry coordinates with associated attribute information as well as connectivity information are stored in a mesh frame, with geometry and attribute information stored as an ordered list of vertex geometry coordinate information with associated attribute information and connectivity information stored as an ordered list of face information with corresponding vertex indices. The geometry and attribute information illustrated in mesh frame 402 includes four vertices. The positions of the vertices are indicated by X, Y, Z coordinates and color attributes are indicated by a_1, a_2, a_3 values that represent the R, G, B color prime values. The connectivity information illustrated in mesh frame 402 includes three faces. Each face includes three vertex indices listed in the geometry and attribute information to form a triangle face. By using the vertex indices for each corresponding face to point to the geometry and attribute information stored for each vertex coordinate, the 3D content 404 (e.g., 3D triangle) can be decoded based on the mesh frames 402.

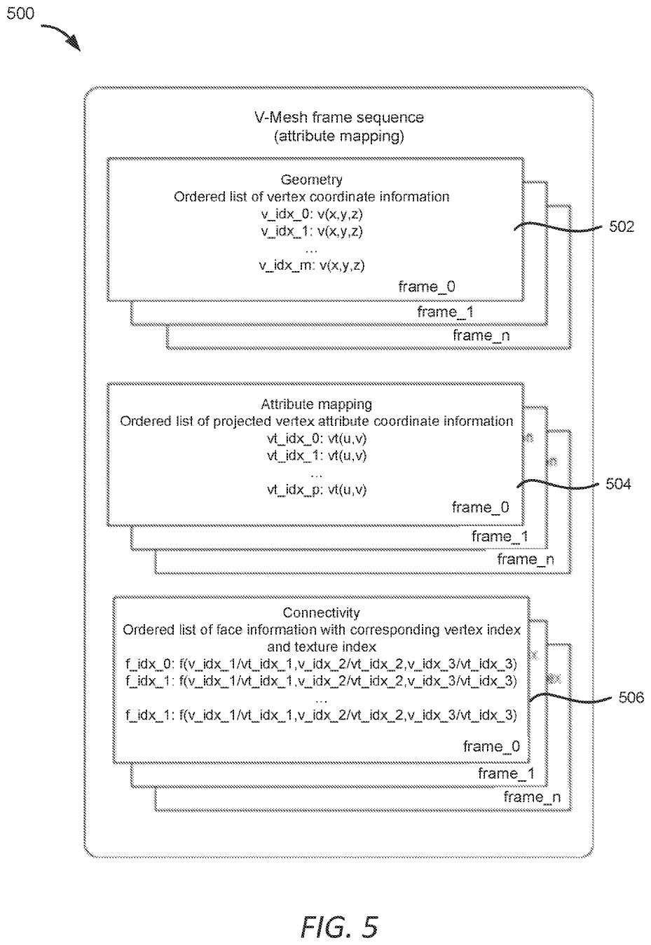

FIG. 5 illustrates example uncompressed mesh frames 500 associated with 3D coding approaches using texture maps, according to various embodiments of the present disclosure. As illustrated in FIG. 5, geometry information 502 can be stored in mesh frames as an ordered list of vertex coordinate information. Each vertex coordinate is stored with corresponding geometry information. Attribute information 504 can be stored in mesh frames, separate from the geometry information 502, as an ordered list of projected vertex attribute coordinate information. The projected vertex attribute coordinate information is stored as 2D coordinate information with corresponding attribute information. Connectivity information 506 can be stored in mesh frames as an ordered list of face information, with each face including corresponding vertex indices and texture indices. In some examples, the mesh frames are formatted according to the wavefront OBJ file format.

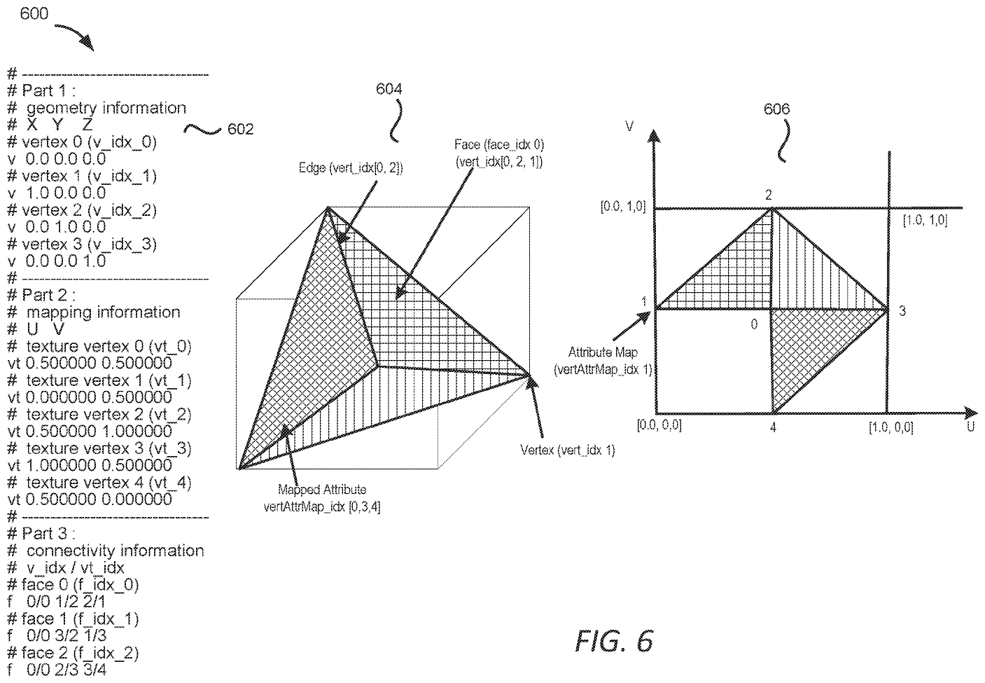

FIG. 6 illustrates an example 600 of data 602 defining a mesh frame, a corresponding 3D content 604, and a corresponding attribute map 606 associated with 3D coding approaches using attribute mapping, according to various embodiments of the present disclosure. As illustrated in FIG. 6, geometry information, mapping information (e.g., attribute information), and connectivity information are stored in the mesh frame generated based on information described in data 602. The geometry information contained in the mesh frame includes four vertices. The positions of the vertices are indicated by X, Y, Z coordinates. The mapping information in the mesh frame includes five texture vertices. The positions of the texture vertices are indicated by U, V coordinates. The connectivity information in the mesh frame includes three faces. Each face includes three pairs of vertex indices and texture vertex coordinates. As illustrated in FIG. 6, by using the pairs of vertex indices and texture vertex coordinates for each face, the 3D content 604 (e.g., the object formed by the triangles in the 3D space) and the attribute map 606 can be decoded based on the mesh frame. Attribute information associated with the attribute map 606 can be applied to the 3D content 604 to apply the attribute information to the 3D content 604. In this example, the coordinates are normalized on a scale from −1.0 to +1.0 for each axis in geometry, and for attribute mapping the coordinates are normalized on a scale from 0.0 to +1.0. The coordinates in the mesh encoder are first converted from a floating-point value to a fixed point representation with a given bit-depth and then compressed by the mesh encoder.

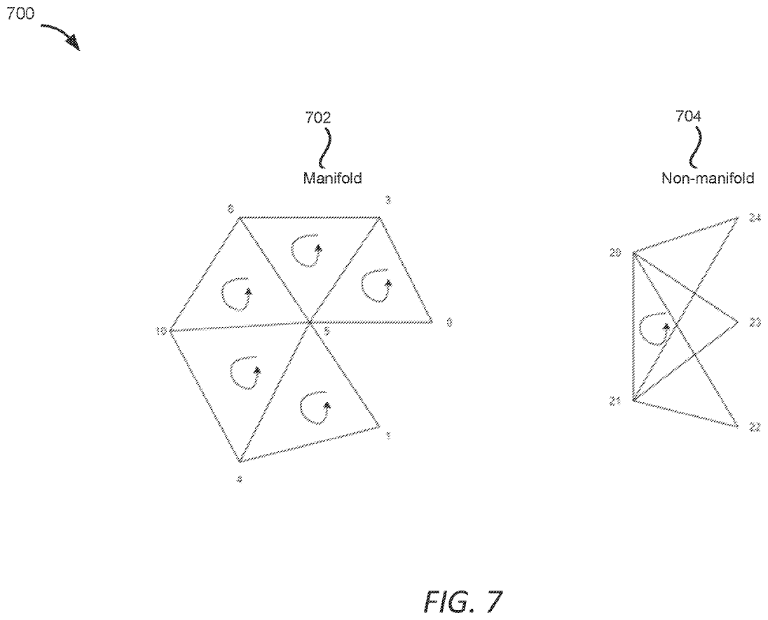

FIG. 7 illustrates an example 700 associated with determining face orientation in various 3D coding approaches, according to various embodiments of the present disclosure. As illustrated in FIG. 7, face orientation can be determined using a right-hand coordinate system. Each face illustrated in the example 700 includes three vertices, forming three edges. Each face is described by the three vertices. In a manifold mesh 702, each edge belongs to at most two different faces. In a non-manifold mesh 704, an edge can belong to two or more different faces. In both cases of the manifold mesh 702 and the non-manifold mesh 704, the right-hand coordinate system can be applied to determine the orientation of a face, which may also be referred to as a normal vector direction or a face normal direction.

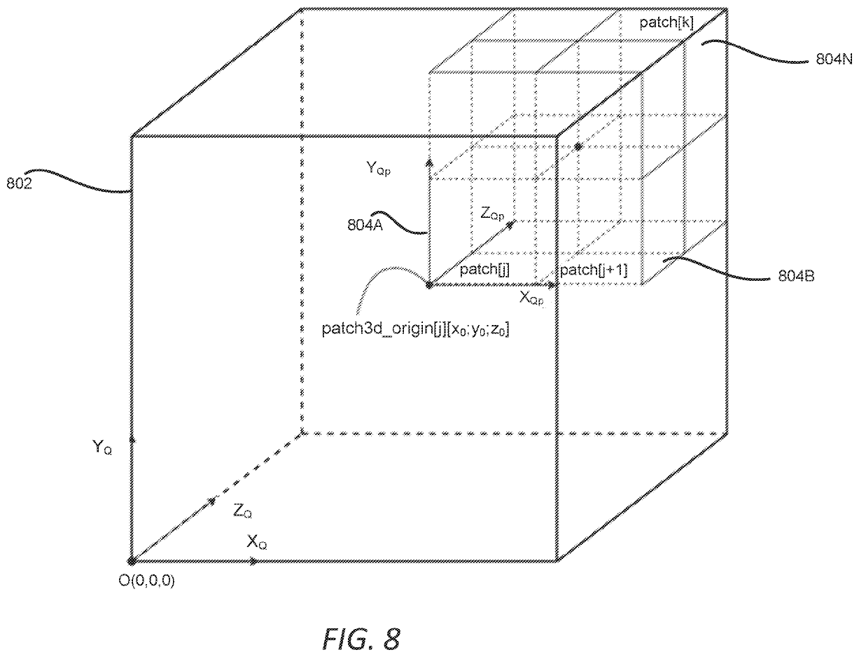

This following discloses geometry component coding and decoding using lossless video coding for integerized 3D coordinates of the vertexes of a 3D dynamic mesh. The disclosed mechanism is applied to vertices v_idx_0 . . . v_idx_N−1 as illustrated in FIGS. 5 and 7 and may be implemented by the geometry image composition module 112 and geometry image decoding module 212 described above with respect to FIGS. 1 and 2, respectively. To code the geometry component, a mesh frame of the dynamic mesh is segmented into 3D sub-blocks, FIG. 8 illustrates an example of the segmentation process for a mesh frame, according to various embodiments of the present disclosure.

In FIG. 8, a mesh frame 802 is shown in a global coordinate system consisting of an X_{Q}-axis, a Y_{Q}-axis, and a Z_{Q}-axis, with an origin at O(0,0,0). Each vertex contained in the mesh frame 802 has a global coordinate (X_{Q}, Y_{Q}, Z_{Q}). FIG. 8 also illustrates multiple 3D sub-blocks 804A-804N contained in the mesh frame 802. Each of the 3D sub-blocks 804 has a local coordinate system consisting of an X_{Qp}-axis, a Y_{Qp}-axis, and a Z_{Qp}-axis and has an origin (0,0,0) in the respective local coordinate system. The origin of each 3D sub-block can also be represented using the coordinates of the global coordinate system. For example, the origin of the 3D sub-block 804A has coordinates (x₀, y₀, z₀) in the global coordinate system. Likewise, each vertex contained in a 3D sub-block can also be represented using the corresponding local coordinates in addition to the global coordinates. Because the 3D sub-block is smaller than the mesh frame 802, coordinates of vertices contained in a 3D sub-block have a smaller range than the coordinates of vertices across the entire mesh frame. As such, the local coordinate values can be represented using fewer bits than the global coordinates.

While FIG. 8 shows eight 3D sub-blocks 804 in the mesh frame 802 adjacent to each other, there can be any number of the 3D sub-blocks in a mesh frame and the 3D sub-blocks can be located at any locations within the mesh frame. In other words, a mesh frame can include one 3D sub-block or multiple 3D sub-blocks. When there are two or more 3D sub-blocks, two 3D sub-blocks can be adjacent to each other or there can be gap between two 3D sub-blocks. In any event, two 3D sub-blocks cannot have overlap. As such, one vertex can only be contained in one 3D sub-block. In addition, the 3D sub-blocks can have different sizes and containing different numbers of vertices.

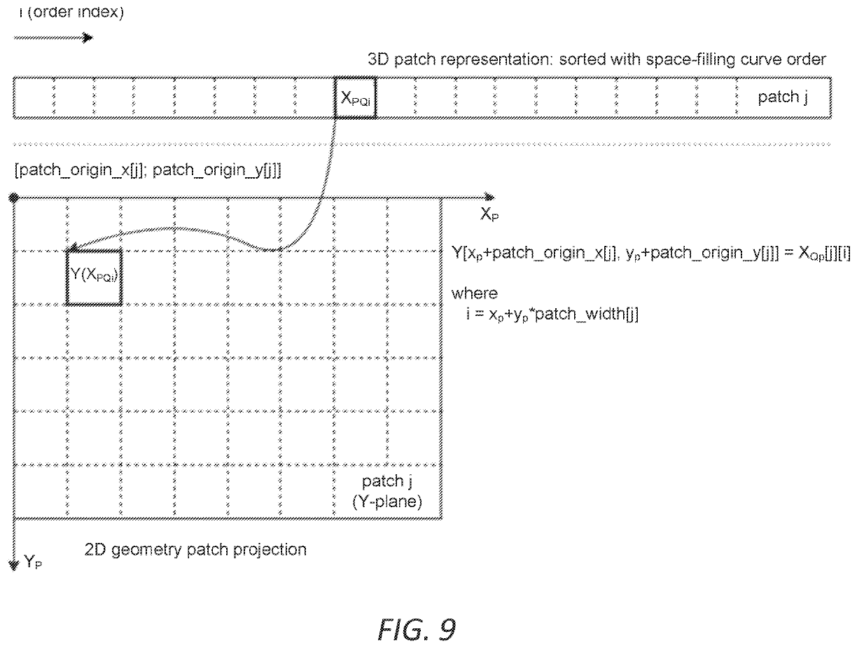

With the 3D sub-blocks, mapping or projecting the vertices in the mesh frame to the geometry composition image can be performed sub-block by sub-block. In other words, vertices in one 3D sub-block can be mapped to one 2D patch in the geometry composition image. FIG. 9 shows an example of mapping vertices in a 3D sub-block to a 2D patch in the geometry composition image, according to various embodiments of the present disclosure. In this example, the vertices in the 3D sub-block are sorted and stored according to a space-filling curve order, such as the Morton order or Hilbert order, to achieve monotonic coordinate value distribution in the projected 2D. The sorting can be performed according to the X coordinate values, then Y axis coordinate values, and then Z coordinate values. Compared with sorting the vertices in the entire mesh frame, sorting vertices in a 3D sub-block can lead to a smoother sorted result because the vertices in the 3D sub-block have smaller coordinate values and variance. As a result, the compression efficiency of the geometry composition image is higher.

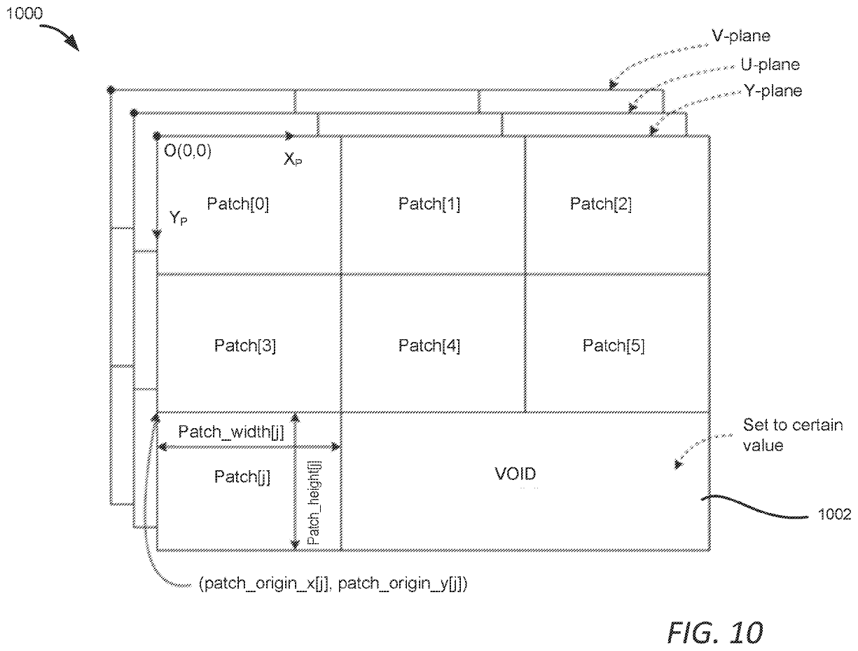

FIG. 10 provides an example of 2D patches in a geometry composition image 1000 generated by the mapping or projection, according to some embodiments of the present disclosure. In this example, the geometry composition image 1000 includes three color planes: Y, U, and V. In some examples, X_{Qp} coordinates of the vertices in the 3D sub-block are projected to the Y plane; Y_{Qp} coordinates are projected to the U plane; and Z_{Qp} coordinates are projected to the V plane. Each color plane includes multiple 2D patches, each 2D patch corresponding to one 3D sub-block in the mesh frame. Each 2D patch j has a patch origin (patch_origin_[j], patch_origin_y[j]) measured relative to the origin of the geometry composition image (0,0) and a size parameter including a patch width patch_width[j] and a patch height patch_height[j]. In some examples, the number of samples in each 2D patch is larger than the number of vertices in the corresponding 3D sub-block.

As shown in FIG. 10, the geometry composition image 1000 can include a void area 1002 that do not include projected values from the mesh frame. Samples in the void area can be set to a certain value and will be ignored at the reconstruction. In some examples, the value can be derived from the neighboring samples to improve the compression efficiency of the geometry composition image. For instance, the samples in the void area 1002 can repeat the last value of the 2D patches in the geometry composition image till the end of the geometry composition image. Alternatively, or additionally, the values can be interpolated from the samples above and to the left of the void area 1002 using an interpolation filter such as bilinear, bicubic, Lanczos filter. In some examples, the samples in the void area 1002 may use the initialized value of the geometry composition image. In addition, while FIG. 10 shows the 2D patches having the same size, different 2D patches may have different sizes, e.g., different heights or different widths.

To encode the geometry vertices as described herein, the global coordinates (X, Y, Z) of each vertex in the mesh frame 802 are normalized to generate normalized coordinates (X_{Q}, Y_{Q}, Z_{Q}). The normalization includes shifting the coordinate values to a positive range and then integerizing them to a geometry bit depth specified for the geometry information of the dynamic mesh. For example, if the X coordinates of the vertices in the mesh frame have a range between −5.37 to 10, the X coordinates are shifted to the range of 0 to 15.37 by adding 5.37 to each X coordinate value. The X coordinates can each be integerized into the geometry bit depth by scaling the coordinates to a range corresponding to the geometry bit depth to generate X_{Q}. For example, if the geometry bit depth is 15 bits, the coordinate range is 0 to 32767. Similar operations can be performed on the Y and Z coordinates to generate Y_{Q} and Z_{Q}, respectively.

Based on the normalized coordinates (X_{Q}, Y_{Q}, Z_{Q}), the bounding box coordinates (xₘᵢₙ, yₘᵢₙ, zₘᵢₙ) and (xₘₐₓ, yₘₐₓ, zₘₐₓ) can be determined. Further, the bounding box maximum size is derived from the bounding box coordinates as follows:

$$bBoxMax = max \{ {x}_{max} - {x}_{min} , {y}_{max} - {y}_{min} , {z}_{max} - {z}_{min} \} \qquad ( 1 )$$

Based on the bounding box coordinates and the geometry bit depth, the geometry integerization parameter Q_{PG} for geometry coordinates can be determined. In some examples, the geometry integerization parameter Q_{PG} and the bounding box coordinates are coded in the bitstream header of the geometry component bitstream.

Based on the geometry integerization parameter Q_{PG} and the bounding box coordinates, the normalized coordinates for each vertex can be represented as a triplets of integer values with a fixed precision as follows:

$$〈 int 〉 {x}_{Q} [ k ] = ( 1 << {Q}_{PG} ) - 1 ) \times ( {v}_{idx} [ k ] [ 0 ] ) - {x}_{min} ) / bBoxMax , \qquad ( 2 )$$

$$〈 int 〉 {y}_{Q} [ k ] = ( 1 << {Q}_{PG} ) - 1 ) \times ( {v}_{idx} [ k ] [ 1 ] ) - {y}_{min} ) / bBoxMax ,$$

$$〈 int 〉 {z}_{Q} [ k ] = ( 1 << {Q}_{PG} ) - 1 ) \times ( {v}_{idx} [ k ] [ 2 ] ) - {z}_{min} ) / bBoxMax ,$$

where “<int> x” represents converting x into an integer number, for example, by rounding x to the nearest integer.

In some examples, the bounding box coordinates, i.e., the minimum and maximum values of the coordinates of the vertices, can be first normalized to a range of [−1,1] before integerization and coding in the bitstream as follows:

$${x}_{max \_ normalized} = {x}_{max} / bBoxMax ; \qquad ( 3 )$$

$${y}_{max \_ normalize} = {y}_{max} / bBoxMax ;$$

$${z}_{max \_ normalized} = {z}_{max} / bBoxMax ;$$

$${x}_{min \_ normalized} = {x}_{min} / bBoxMax ;$$

$${y}_{min \_ normalized} = {y}_{min} / bBoxMax ;$$

$${z}_{min \_ normalized} = {z}_{min} / bBoxMax .$$

The integerized coordinates x_{Q}[i], y_{Q}[i], and z_{Q}[i] are further segmented into 3D sub-blocks (also referred to as 3D patches) based on the absolute coordinate values of the vertex in a manner to fit into desired video bit-depth as shown in FIG. 8. The video bit-depth can be indicated in the sequence parameter set (SPS) or the geometry sequence parameter set (GSPS) of the geometry component bitstream. As discussed above, the vertices inside a 3D sub-block can be additionally sorted and stored according to the space-filling curve order, such as the Morton order or the Hilbert order, to achieve monotonic value distribution in the projected 2D patch in the geometry composition image.

Each 3D sub-block j may be characterized by the 3D position offset (the origin of the 3D sub-block) patch3d_origin[j] which has coordinates (x₀[j], y₀[j], z₀[j]) as shown in FIG. 8. Corresponding vertex coordinates for a vertex with index i inside sub-block j are converted from the global frame coordinate system (x_{Q}, y_{Q}, z_{Q}) to the local sub-block j coordinate system (x_{QP}, y_{QP}, z_{QP}) using the following equation:

$${x}_{Qp} [ j ] [ i ] = {x}_{Q} [ k ] - {x}_{0} [ j ] ; \qquad ( 4 )$$

$${y}_{Qp} [ j ] [ i ] = {y}_{Q} [ k ] - {y}_{0} [ j ] ;$$

$${z}_{Qp} [ j ] [ i ] = {z}_{Q} [ k ] - {z}_{0} [ j ] .$$

The converted coordinates (x_{Qp}, y_{Qp}, z_{Qp}) have smaller values than the global frame coordinates (x_{Q}, y_{Q}, z_{Q}). As such, the number of bits needed to represent the converted coordinates is smaller than the number of bits needed to represent the global frame coordinates. These converted coordinates can thus fit into the video bit-depth which is lower than the geometry bit depth.

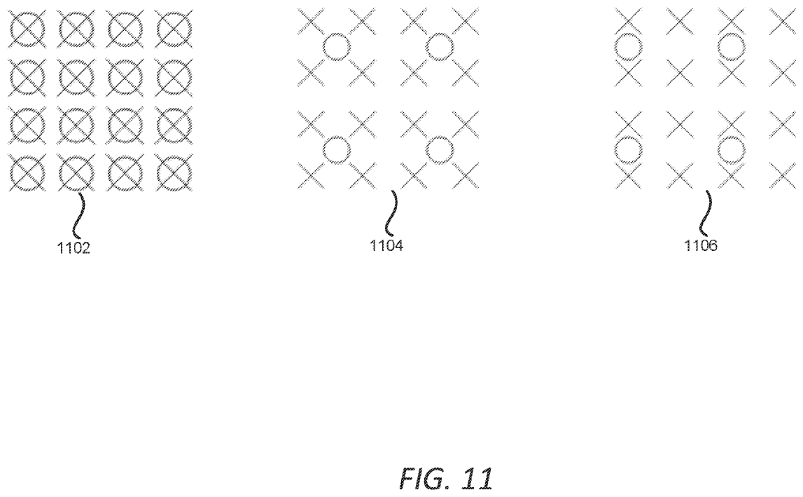

The 3D blocks with converted coordinates can thus be mapped or projected to the 2D patches in the geometry composition image. The geometry composition image can be initialized with initial values, such as 0, 127, 511 or (2\hat{ }(video-bit-depth>>1)−1). In some examples, the projection involves mapping the (x_{Qp}, y_{Qp}, z_{QP}) coordinates in a 3D sub-block to the Y, U, V color planes of a 2D patch, respectively. The projection is performed based on the color space of the geometry composition image. FIG. 11 illustrates examples of color space subsampling for geometry coding, according to various embodiments of the present disclosure. If the color space subsampling of the geometry composition image is color space 1102 which represents YUV 4:4:4, each converted coordinate for vertexes is assigned to a corresponding color plane Y, U, and V in 4:4:4 color sampling format as follows:

$$Y [ {x}_{p} + {patch\_origin}_{x} [ j ] , {y}_{p} + {patch\_origin}_{y} [ j ] ] = {x}_{Qp} [ j ] [ {x}_{p} + {y}_{p} * patch\_width [ j ] ] \qquad ( 5 )$$

$$U [ {x}_{p} + {patch\_origin}_{x} [ j ] , {y}_{p} + {patch\_origin}_{y} [ j ] ] = {y}_{Qp} [ j ] [ {x}_{p} + {y}_{p} * patch\_width [ j ] ]$$

$$V [ {x}_{p} + {patch\_origin}_{x} [ j ] , {y}_{p} + {patch\_origin}_{y} [ j ] ] = {z}_{Qp} [ j ] [ {x}_{p} + {y}_{p} * patch\_width [ j ] ]$$

where (patch_originₓ[j], patch_origin_{y}[j]) are the 2D coordinates of the origin of the 2D patch j in the geometry composition image; (xₚ, yₚ) are the coordinates of a sample in the 2D patch j; and patch_width[j] is the width of the 2D patch j.

If the color space subsampling of the geometry composition image is the colorspace 1104 or color space 1106 representing YUV 4:2:0, each converted coordinate for vertexes is assigned to a corresponding color plane Y, U, and V in 4:2:0 color sampling format as follows:

$$for ( m = 0 , m < 2 , m ++ ) \qquad ( 6 )$$

$$for ( n = 0 , n < 2 , n ++ )$$

$$\{$$

$$Y [ {x}_{p} + m + {patch\_origin}_{x} ( j ) , {y}_{p} + n + {patch\_origin}_{y} [ j ] ] =$$

$${x}_{Q p} [ j ] [ {x}_{p} + {y}_{p} * patch\_width [ j ] ]$$

$$\}$$

$$U [ {x}_{p} + {patch\_origin}_{x} ( j ) , {y}_{p} + {patch\_origin}_{y} [ j ] ] = {y}_{Q p} [ j ] [ {x}_{p} + {y}_{p} * patch\_width [ j ] ]$$

$$V [ {x}_{p} + {patch\_origin}_{x} ( j ) , {y}_{p} + {patch\_origin}_{y} [ j ] ] = {z}_{Q p} [ j ] [ {x}_{p} + {y}_{p} * patch\_width [ j ] ]$$

In some examples, information regarding the 3D sub-block and the 2D patch is stored in the atlas component of the dynamic mesh. The 2D patch information for 2D patch j includes the projection origin point (patch_originₓ[j], patch_origin_{y}[j]), the number of vertices patch_num_points[j], and the size of the patch patch_width[j] and patch_height[j]. The information for 3D sub-block j includes the coordinates of the origin (x₀[j], y₀[j], z₀[j]).

The 2D patch information and 3D sub-block information can be directly coded in the atlas component. Alternatively, or additionally, these types of information can be delta coded to achieve more compact data representation in the atlas component. For example, the projected patch 2D origin can be coded using the difference between the current patch origin and the previous patch origin:

$$delta\_patch {\_origin}_{x} [ j ] = {patch\_origin}_{x} [ j ] - {patch\_origin}_{x} [ j - 1 ] , \qquad ( 7 )$$

$$delta\_patch {\_origin}_{y} [ j ] = {patch\_origin}_{y} [ j ] - {patch\_origin}_{y} [ j - 1 ] .$$

Likewise, the projected patch size can be delta coded using the difference between the current patch size and the previous patch size:

$$delta\_patch \_width [ j ] = patch width [ j ] = patch\_width [ j - 1 ] , \qquad ( 8 )$$

$$della\_patch \_height [ j ] = patch\_height [ j ] - patch\_height [ j - 1 ] .$$

The number of points per patch can be delta coded using the

$$delta\_patch \_num \_point [ j ] = patch\_num \_points [ j ] - patch\_num \_points [ j - 1 ] . \qquad ( 9 )$$

3D subblock origin point can be delta coded using the difference between the current 3D sub-block origin and the previous 3D sub-block origin:

$${delta}_{{x}_{0}} [ j ] = {x}_{0} [ j ] - {x}_{0} [ j - 1 ] , \qquad ( 10 )$$

$${delta}_{{y}_{0}} [ j ] = {y}_{0} [ j ] - {y}_{0} [ j - 1 ] ,$$

$${delta}_{{z}_{0}} [ j ] = {z}_{0} [ j ] - {z}_{0} [ j - 1 ] .$$

Alternatively, the size of the projected patch patch_width[j] and patch_height[j] may be fixed and thus does not need to be signaled in the atlas component per each patch. Instead, projected patch size is determined by the encoder parameters, or as user input. As one example patch_width[j] and patch_height[j] is set to 64 allowing a patch to hold up to 4096 vertex coordinates.

In some examples, the size of the 2D patch j, or more specifically, the number of samples in the 2D patch j (patch_width[j]*patch_height[j]) is no smaller than the number of vertices in the corresponding 3D sub-block j. If the size of the 2D patch j is larger than the number of vertices in the 3D sub-block j, then the remaining values in the 2D patch are not used in the reconstruction and can be populated with values derived from the neighboring samples. As discussed above, the remaining samples of the projected 2D patch can repeat the last value till the end of the patch. Alternatively, or additionally, the remaining values can be interpolated from the samples above and to the left, using interpolation filter such as bilinear filter, bicubic filter, Lanczos filter, or another interpolation filter. In some examples, the remaining samples in the 2D patch use the initialized value. The geometry composition image is further coded with lossless video coding to generate the geometry component bitstream.

To decode the geometry component bitstream and reconstruct the geometry vertices, the geometry component decoder, such as the geometry image decoding module 212, decodes the video bitstream for the geometry component into geometry composition images. The geometry component decoder can further obtain, from the geometry component bitstream header, the integerization parameter Q_{PG} and global frame offset parameters including the bounding box coordinates (xₘᵢₙ, yₘᵢₙ, zₘᵢₙ) (xₘₐₓ, Yₘₐₓ, Zₘₐₓ). Further, the geometry component decoder can decode, from the atlas bitstream, 2D patch information and the 3D sub-block information. As discussed above, the 2D patch information for patch j includes the number of samples in patch j patch_num_poitns[j], the size information patch_width[j], patch_height[j], the origin of the patch (patch_origin_x[j], patch_origin_y[j]). The 3D sub-block information includes the origin of the 3D sub-block j (x₀[j], y₀[j], z₀[j]). Depending on the encoding methods of the 2D patch information and 3D sub-block information, the values in 2D patch information and 3D sub-block information can be decoded directly from the atlas bitstream. Alternatively, or additionally, the delta information is decoded from the atlas bitstream and the actual values can be reconstructed based on the decoded delta information.

The geometry component decoder can reconstruct the 3D local coordinates from the 2D patches by performing an inverse process of the projection described above. For example, the geometry component decoder can convert color information from the corresponding color plane of the decoded video to 3D coordinates in a local sub-block coordinate system. As described above for the encoding process, the conversion can be performed according to the color space of the decoded video. For YUV 4:2:0 color space, the coordinate values of a geometry vertex in the 3D sub-block x_{QR} [j][i], y_{QR}[j][i], and z_{QR} [j][i] can be assigned to the values of the projected sample Y[xₚ, yₚ], U[xₚ, yₚ], and V[xₚ, yₚ], respectively, as follows:

$${x}_{Q p} [ j ] [ i ] = Y [ 2 {x}_{p} + {patch\_origin}_{x} [ j ] , 2 {y}_{p} + {patch\_origin}_{y} [ j ] ] \qquad ( 11 )$$

$${y}_{Q p} [ j ] [ i ] = U [ {x}_{p} + {patch\_origin}_{x} [ j ] , {y}_{p} + {patch\_origin}_{y} [ j ] ]$$

$${z}_{Q p} [ j ] [ i ] = V [ {x}_{p} + {patch\_origin}_{x} [ j ] , {y}_{p} + {patch\_origin}_{y} [ j ] ]$$

Alternatively, x_{QpR} [j][i], y_{QpR}[j][i], and z_{QpR}[j][i] can be determined as:

$$for ( m = 0 , m < 2 , m ++ ) \qquad ( 12 )$$

$$for ( n = 0 , n < 2 , n ++ )$$

$$\{$$

$${x}_{Q p} [ j ] [ i ] +=$$

$$Y [ {x}_{p} + m + {patch\_origin}_{x} [ j ] , {y}_{p} + n$$

$$+ {patch\_origin}_{y} [ j ] ] / 4$$

$$\}$$

$${y}_{Q p} [ j ] [ i ] = U [ {x}_{p} + {patch\_origin}_{x} [ j ] , {y}_{p} + {patch\_origin}_{y} [ j ] ]$$

$${z}_{Q p} [ j ] [ i ] = V [ {x}_{p} + {patch\_origin}_{x} [ j ] , {y}_{p} + {patch\_origin}_{y} [ j ] ] .$$

For YUV 4:4:4 colorspace, the coordinate values of a geometry vertex in the 3D sub-block x_{QpR} [j][i], y_{QpR} [j][i], and z_{QR} [j][i] can be assigned to the values of the projected sample Y[xₚ, yₚ], U[xₚ, yₚ], and V[xₚ, yₚ], respectively, as follows:

$${x}_{Q p} [ j ] [ i ] = Y [ {x}_{p} + {patch\_origin}_{x} [ j ] , {y}_{p} + {patch\_origin}_{y} [ j ] ] \qquad ( 13 )$$

$${y}_{Q p} [ j ] [ i ] = U [ {x}_{p} + {patch\_origin}_{x} [ j ] , {y}_{p} + {patch\_origin}_{y} [ j ] ]$$

$${z}_{Q p} [ j ] [ i ] = V [ {x}_{p} + {patch\_origin}_{x} [ j ] , {y}_{p} + {patch\_origin}_{y} [ j ] ]$$

The local reconstructed coordinates of the vertices can be used to reconstruct the global coordinates of each vertex by shifting the local reconstructed coordinates according to the origin of the corresponding 3D sub-block as follows:

$${x}_{Q} [ k ] = {x}_{Q p} [ j ] [ i ] + {x}_{0} [ j ] , \qquad ( 14 )$$

$${y}_{Q} [ k ] = {y}_{Q p} [ j ] [ i ] + {y}_{0} [ j ] ,$$

$${z}_{Q} [ k ] = {z}_{Q p} [ j ] [ i ] + {z}_{0} [ j ] .$$

In cases where the number of decoded samples in the 2D patch j is larger than the number of vertices patch_num_points[j] in the corresponding 3D sub-block j, the values with index (xₚ, yₚ) where xₚ+yₚ*patch_width[j]>patch_num_points[j] are ignored. The number of vertices patch_num_points[j] can be decoded from the atlas component.

The geometry coordinates of the vertices can be reconstructed by applying the inverse integerization to the global coordinates of each vertex as follows:

$$v\_idx [ k ] [ 0 ] = ( {x}_{Q} [ k ] / ( 1 << {Q}_{P G} ) - 1 ) \times bBoxMax + {x}_{min} , \qquad ( 15 )$$

$$v\_idx [ k ] [ 1 ] = ( {y}_{Q} [ k ] / ( 1 << {Q}_{P G} ) - 1 ) \times bBoxMax + {y}_{min} ,$$

$$v\_idx [ k ] [ 2 ] = ( {z}_{Q} [ k ] / ( 1 << {Q}_{P G} ) - 1 ) \times bBoxMax + {z}_{min} .$$

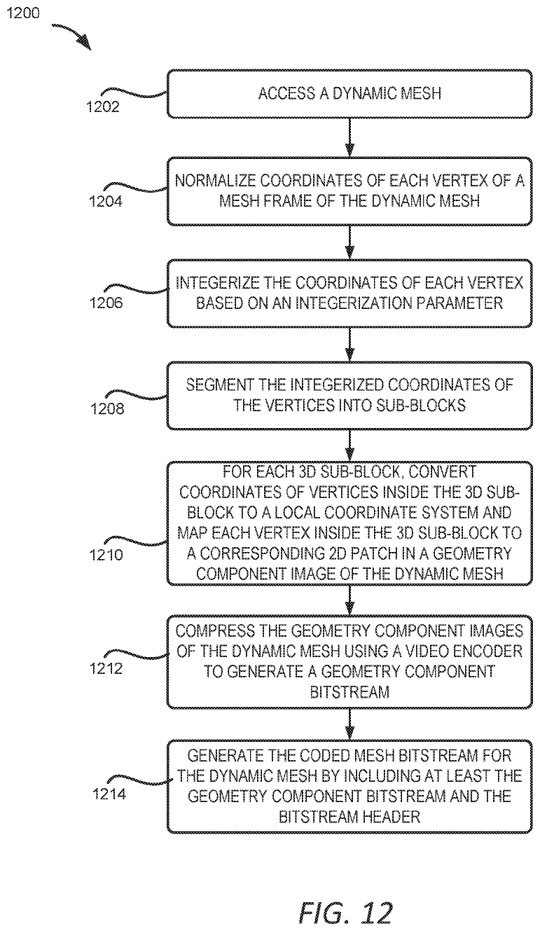

Referring now to FIG. 12, FIG. 12 depicts an example of a process 1200 for dynamic mesh coding with efficient geometry component coding, according to some embodiments of the present disclosure. One or more computing devices implement operations depicted in FIG. 1200 by executing suitable program code. For example, the encoder system 100 in FIG. 1 may implement the operations depicted in FIG. 1200 by executing the corresponding program code. For illustrative purposes, the process 1200 is described with reference to some examples depicted in the figures. Other implementations, however, are possible.

At block 1202, the process 1200 involves accessing a dynamic mesh to be encoded. As discussed above, the dynamic mesh may be represented as uncompressed mesh frame sequence that include mesh frames. A mesh frame is a data format that describes 3D content (e.g., 3D objects) in a digital representation as a collection of geometry, connectivity, attribute, and attribute mapping information. The geometry information of a mesh frame includes coordinates of vertices in the global coordinate system of the mesh frame. Each mesh frame is characterized by a presentation time and duration. A mesh frame sequence (e.g., sequence of mesh frames) forms a dynamic mesh video. The uncompressed mesh frame sequence can be segmented into segmented mesh data. Based on the segmented mesh data, the encoder system 800 can generate attribute component images, geometry component images, connectivity component images, and mapping component images.

At block 1204, the process 1200 involves normalizing the coordinates of vertices of a mesh frame. For example, the normalization can include converting the coordinates of the vertices into a positive range and integerizing the converted coordinates to fit into the geometry bit depth. At block 1206, the process 1200 involves integerizing the coordinates of each vertex based on an integerization parameter for geometry coordinates. Coordinates of a bounding box of the vertices can be determined based on the normalized coordinates of the vertices in the mesh frame. Based on the bounding box and the geometry bit depth for the dynamic mesh, the integerization parameter can be determined. The coordinates of the bounding box and the integerization parameter can be stored in the bitstream header of the geometry component bitstream.

At block 1208, the process 1200 involves segmenting the integerized coordinates of the vertices in the mesh frame into 3D sub-blocks. In some examples, each 3D sub-block contains at least one vertex of the vertices in the mesh frame and each vertex of the mesh frame belongs to one and only one 3D sub-block. The segmentation is performed such that local coordinates of vertices in each 3D sub-block have a value range fitting into the video bit depth of the geometry composition image corresponding to the mesh frame. In some examples, the video bit depth is specified in a sequence parameter set or a geometry sequence parameter set of the geometry component bitstream.

At block 1210, the process 1200 involves, for each 3D sub-block, converting coordinates of a vertex inside the 3D sub-block to a local coordinate system of the 3D sub-block and mapping the vertex to a corresponding 2D patch in a geometry component image of the dynamic mesh. As discussed in detail above, the converting and mapping may be performed according to Eqn. (4) and Eqn. (5) (or Eqn. (6)), respectively. In addition, the vertices in the 3D sub-block can be sorted according to a space-filling curve order. The mapping can be performed according to the space-filling curve order to improve the coding efficiency of the geometry composition image. Blocks 1204 to 1210 may be performed for multiple mesh frames.

At block 1212, the process 1200 involves compressing the geometry component images of the dynamic mesh using a video encoder to generate a geometry component bitstream. As discussed above in detail with respect to FIG. 1, the encoding may involve using a lossless video encoder to generate the geometry component bitstream. At block 1214, the process 1200 involves generating a coded mesh bitstream by including at least the geometry component bitstream. For example, the coded mesh bitstream can be generated by multiplexing the mesh bitstream payload, that includes the geometry component bitstream and other bitstreams such as the connectivity component bitstream, attribute component bitstream, mapping component bitstream, and so on, with a mesh bitstream header.

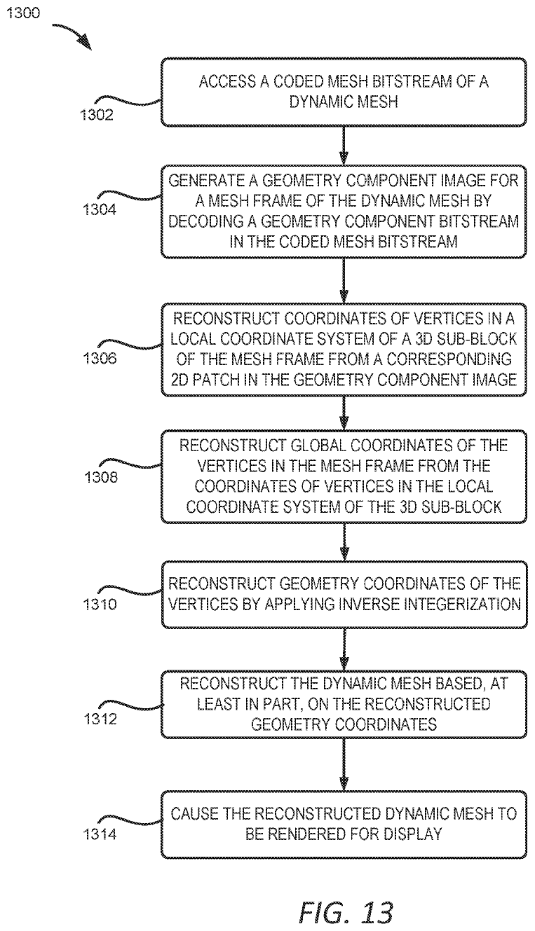

Referring now to FIG. 13, FIG. 13 depicts an example of a process 1300 for decoding a coded mesh bitstream with efficient geometry component coding, according to some embodiments of the present disclosure. One or more computing devices implement operations depicted in FIG. 1300 by executing suitable program code. For example, the decoder system 200 in FIG. 2 may implement the operations depicted in FIG. 1300 by executing the corresponding program code. For illustrative purposes, the process 1300 is described with reference to some examples depicted in the figures. Other implementations, however, are possible.

At block 1302, the process 1300 involves accessing a coded mesh bitstream of a dynamic mesh for decoding. The coded mesh bitstream is encoded with the efficient geometry component encoding described above. The coded mesh bitstream can include a geometry component bitstream and other bitstreams such as an attribute component bitstream, a connectivity component bitstream, and a mapping component bitstream.

At block 1304, the process 1300 involves generating a geometry component image for a mesh frame of the dynamic mesh by decoding the geometry component bitstream in the coded mesh bitstream. As discussed above in detail with respect to FIG. 2, the geometry information of the dynamic mesh can be reconstructed from the geometry component bitstream by applying a video decoder to the geometry component bitstream to generate reconstructed geometry component images.

At block 1306, the process 1300 involves reconstructing coordinates of vertices in a local coordinate system of a 3D sub-block of the mesh frame from a corresponding 2D patch in the geometry component image. As discussed in detail above, the reconstruction can be performed by converting color information from color planes of the corresponding 2D patch to the coordinates of vertices in the local coordinate system of the 3D sub-block, such as according to Eqn. (11), (12) or (13). The conversion can be performed based on the patch information that is decoded for the 2D patch from an atlas bitstream. The patch information can include, for example, the number of vertices in the 2D patch, the 2D coordinates of an origin of the 2D patch, the size of the 2D patch, and the coordinates of an origin of the 2D patch, and so on.

At block 1308, the process 1300 involves reconstructing global coordinates of the vertices in the mesh frame from the coordinates of vertices in the local coordinate system of the 3D sub-block. As described above, the reconstruction can be performed based on the coordinates of the origin of the 3D block, such as according to Eqn. (14). At block 1310, the process 1300 involves reconstructing geometry coordinates of the vertices by applying inverse integerization based on integerization parameter for geometry information of the dynamic mesh as formulated in Eqn. (15). The integerization parameter can be decoded from the bitstream header of the geometry component bitstream. At block 1312, the process 1300 involves reconstructing the dynamic mesh based on the reconstructed geometry information and other information including the connectivity information, the attribute information, the mapping information, and so on. At block 1314, the process 1300 involves causing the reconstructed dynamic mesh to be rendered for display. For example, the reconstructed dynamic mesh can be transmitted to a device or a module configured to render the 3D object represented by the reconstructed dynamic mesh to generate rendered images or video for display.

### Computing System Example

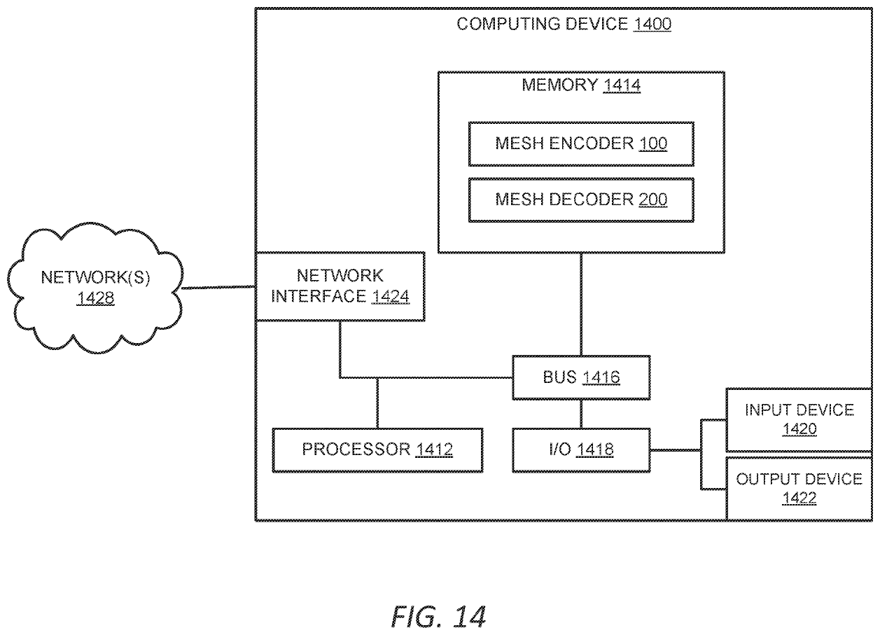

Any suitable computing system can be used for performing the operations described herein. For example, FIG. 14 depicts an example of a computing device 1400 that can implement the mesh encoder 100 of FIG. 1, the mesh decoder 200 of FIG. 2. In some embodiments, the computing device 1400 can include a processor 1412 that is communicatively coupled to a memory 1414 and that executes computer-executable program code and/or accesses information stored in the memory 1414. The processor 1412 may comprise a microprocessor, an application-specific integrated circuit (“ASIC”), a state machine, or other processing device. The processor 1412 can include any of a number of processing devices, including one. Such a processor can include or may be in communication with a computer-readable medium storing instructions that, when executed by the processor 1412, cause the processor to perform the operations described herein.

The memory 1414 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 1400 can also include a bus 1416. The bus 1416 can communicatively couple one or more components of the computing device 1400. The computing device 1400 can also include a number of external or internal devices such as input or output devices. For example, the computing device 1400 is shown with an input/output (“I/O”) interface 1418 that can receive input from one or more input devices 1420 or provide output to one or more output devices 1422. The one or more input devices 1420 and one or more output devices 1422 can be communicatively coupled to the I/O interface 1418. The communicative coupling can be implemented via any suitable manner (e.g., a connection via a printed circuit board, connection via a cable, communication via wireless transmissions, etc.). Non-limiting examples of input devices 1420 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1422 include an LCD screen, an external monitor, a speaker, or any other device that can be used to display or otherwise present outputs generated by a computing device.

The computing device 1400 can execute program code that configures the processor 1412 to perform one or more of the operations described above with respect to FIGS. 1-13. The program code can include the mesh encoder 100 of FIG. 1 or the mesh decoder 200 of FIG. 2. The program code may be resident in the memory 1414 or any suitable computer-readable medium and may be executed by the processor 1412 or any other suitable processor.

The computing device 1400 can also include at least one network interface device 1424. The network interface device 1424 can include any device or group of devices suitable for establishing a wired or wireless data connection to one or more data networks 1428. Non-limiting examples of the network interface device 1424 include an Ethernet network adapter, a modem, and/or the like. The computing device 1400 can transmit messages as electronic or optical signals via the network interface device 1424.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied for example, blocks can be re-ordered, combined, and/or broken into sub-blocks. Some blocks or processes can be performed in parallel.

The use of “adapted to” or “configured to” herein is meant as an open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A computer-implemented method for encoding three-dimensional (3D) content represented by a dynamic mesh, the method comprising:
normalizing coordinates of each vertex of a plurality of vertices in a mesh frame of the dynamic mesh;
integerizing the coordinates of each vertex of the plurality of vertices;
segmenting the integerized coordinates for the plurality of vertices into one or more 3D sub-blocks, each 3D sub-block containing at least one vertex of the plurality of vertices, and local coordinates of vertices in each 3D sub-block having a value range fitting into a video bit depth;
for each 3D sub-block,
converting coordinates of a vertex inside the 3D sub-block to a local coordinate system of the 3D sub-block; and
mapping each vertex inside the 3D sub-block to a corresponding 2D patch in a geometry component image of the dynamic mesh that represents the mesh frame;
compressing the geometry component image and other geometry component images of the dynamic mesh using a video encoder to generate a geometry component bitstream; and
generating a coded mesh bitstream for the dynamic mesh by including at least the geometry component bitstream.

2. The computer-implemented method of claim 1, wherein normalizing the coordinates of a vertex in the mesh frame of the dynamic mesh comprises:
converting the coordinates of the vertex into a positive range; and
integerizing the converted coordinates to fit into a geometry bit depth.

3. The computer-implemented method of claim 1, further comprising:
determining coordinates of a bounding box based on the normalized coordinates of the vertices in the mesh frame; and
storing the coordinates of the bounding box in a bitstream header of the geometry component bitstream.

4. The computer-implemented method of claim 3, wherein integerizing the coordinates of each vertex of the plurality of vertices is performed based on an integerization parameter for geometry coordinates that is determined based on the bounding box and a geometry bit depth for the dynamic mesh, and wherein the integerization parameter is stored in the bitstream header of the geometry component bitstream.

5. The computer-implemented method of claim 1, wherein the video bit depth is specified in a sequence parameter set or a geometry sequence parameter set of the geometry component bitstream.

6. The computer-implemented method of claim 1, wherein the geometry component image comprises a Y plane, a U plane, and a V plane, and wherein mapping each vertex inside the 3D sub-block to a corresponding 2D patch in the geometry component image of the dynamic mesh comprises:
mapping a first coordinate of the vertex to a first value in the Y plane of the corresponding 2D patch;
mapping a second coordinate of the vertex to a second value in the U plane of the corresponding 2D patch; and
mapping a third coordinate of the vertex to a third value in the V plane of the corresponding 2D patch.

7. The computer-implemented method of claim 1, wherein each vertex of the plurality of vertices belongs to one and only one 3D sub-block.

8. The computer-implemented method of claim 1, further comprising:
for each 3D sub-block, sorting the vertices in the 3D sub-block according to a space-filling curve order, wherein mapping each vertex inside the 3D sub-block to the corresponding 2D patch is performed according to the space-filling curve order.

9. A non-transitory computer-readable medium storing a coded mesh bitstream generated according to the following operations:
normalizing coordinates of each vertex of a plurality of vertices in a mesh frame of a dynamic mesh;
integerizing the coordinates of each vertex of the plurality of vertices;
segmenting the integerized coordinates for the plurality of vertices into one or more 3D sub-blocks, each 3D sub-block containing at least one vertex of the plurality of vertices, and local coordinates of vertices in each 3D sub-block having a value range fitting into a video bit depth;
for each 3D sub-block,
converting coordinates of a vertex inside the 3D sub-block to a local coordinate system of the 3D sub-block, and
mapping each vertex inside the 3D sub-block to a corresponding 2D patch in a geometry component image of the dynamic mesh that represents the mesh frame;
compressing the geometry component image and other geometry component images of the dynamic mesh using a video encoder to generate a geometry component bitstream; and
generating the coded mesh bitstream for the dynamic mesh by including at least the geometry component bitstream.

10. The non-transitory computer-readable medium of claim 9, wherein normalizing the coordinates of a vertex in the mesh frame of the dynamic mesh comprises:
converting the coordinates of the vertex into a positive range; and
integerizing the converted coordinates to fit into a geometry bit depth.

11. The non-transitory computer-readable medium of claim 9, wherein the operations further comprise:
determining coordinates of a bounding box based on the normalized coordinates of the vertices in the mesh frame; and
storing the coordinates of the bounding box in a bitstream header of the geometry component bitstream.

12. The non-transitory computer-readable medium of claim 11, wherein integerizing the coordinates of each vertex of the plurality of vertices is performed based on an integerization parameter for geometry coordinates that is determined based on the bounding box and a geometry bit depth for the dynamic mesh, and wherein the integerization parameter is stored in the bitstream header of the geometry component bitstream.

13. The non-transitory computer-readable medium of claim 9, wherein the video bit depth is specified in a sequence parameter set or a geometry sequence parameter set of the geometry component bitstream.

14.-20. (canceled)

21. A computer-implemented method for decoding a coded mesh bitstream of a dynamic mesh representing three-dimensional (3D) content, the method comprising:
generating a geometry component image for a mesh frame of the dynamic mesh by decoding a geometry component bitstream in the coded mesh bitstream;
reconstructing coordinates of vertices in a local coordinate system of a 3D sub-block of the mesh frame from a corresponding 2D patch in the geometry component image by converting color information from color planes of the corresponding 2D patch to the coordinates of vertices in the local coordinate system of the 3D sub-block;
reconstructing global coordinates of the vertices in the mesh frame from the coordinates of vertices in the local coordinate system of the 3D sub-block;
reconstructing geometry coordinates of the vertices by applying inverse integerization based on integerization parameter for geometry information of the dynamic mesh;
reconstructing the dynamic mesh based, at least in part, on the reconstructed geometry coordinates; and
causing the reconstructed dynamic mesh to be rendered for display.

22. The computer-implemented method of claim 21, wherein the integerization parameter is decoded from a bitstream header of the geometry component bitstream.

23. The computer-implemented method of claim 21, further comprising:
decoding patch information for the 2D patch from an atlas bitstream; and
converting the color information from the color planes of the 2D patch to the coordinates of vertices in the local coordinate system of the 3D sub-block is performed based on the patch information.

24. The computer-implemented method of claim 23, wherein the patch information for the 2D patch comprises:
a number of vertices in the 2D patch;
2D coordinates of an origin of the 2D patch;
a size of the 2D patch; and
coordinates of an origin of the 2D patch.

25. The computer-implemented method of claim 24, wherein converting the color information from the color planes of the 2D patch to the coordinates of vertices in the local coordinate system of the 3D sub-block is performed further based on a color space of the geometry component image.

26. The computer-implemented method of claim 24, wherein the 2D patch comprises a Y plane, a U plane, and a V plane, and wherein converting the color information from the color planes of the 2D patch to the coordinates of vertices in the local coordinate system of the 3D sub-block comprises:
converting a first value in the Y plane of the 2D patch to a first coordinate of a vertex in the 3D sub-block;
converting a second value in the U plane of the 2D patch that corresponds to the first value in the Y plane to a second coordinate of the vertex in the 3D sub-block; and
converting a third value in the V plane of the 2D patch that corresponds to the first value in the Y plane to a third coordinate of the vertex in the 3D sub-block.

27. The computer-implemented method of claim 21, wherein decoding the geometry component bitstream is performed via lossy video encoding.

28.-40. (canceled)
